(19) United States
(12) Patent Application Publication
(10) Pub. No.: US 2008/0172570 A1
(43) Pub. Date: Jul. 17, 2008

(54) DATA LINE REPAIR MECHANISM AND METHOD FOR A DISPLAY

(75) Inventors: Chih-Che Hsu, Hsinchu (TW); Hung-Min Shih, Hsinchu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: AU OPTRONICS CORP., Hsinchu (TW)

(21) Appl. No.: 11/942,746

(22) Filed: Nov. 20, 2007

(30) Foreign Application Priority Data
Jan. 15, 2007 (TW) 96101461

(51) Int. Cl. G06F 11/14

(52) U.S. Cl. 714/3; 714/E11.113

(57) ABSTRACT

A data line repair mechanism for a display including a data driver, a plurality of data lines, at least one rescue line is disclosed, wherein each data line includes a second end and a first end coupled to the data driver, the rescue line is coupled to the data driver, and when a first data line fails, the rescue line is coupled to the second end of the first data line via a single one weld point. The mechanism includes an address storage unit storing the addresses of the first data line and rescue line, and a data processor receiving an input data to output an output data to the data driver, wherein the input data includes a first display data corresponding to the first data line, and the first display data is transmitted to the rescue line based on the addresses of the first data line and rescue line.

### BACKGROUND OF THE INVENTION

1. Field of the Invention

The invention relates to a data line repair mechanism for a display, and more particularly to a data line repair mechanism using a single one weld point for one defective data line in a liquid crystal display.

2. Description of the Related Art

FIG. 1 is a schematic diagram of a conventional liquid crystal display. The liquid crystal display 1 comprises a pixel array 10, a data driver 11 and a scan driver (or so-called gate driver) 12. The data driver 11 controls data lines D₁ to Dₘ, and the scan driver controls the scan lines (or so-called gate line) G₁ to Gₙ. The pixel array is formed by the interleaved data lines D₁ to Dₘ and scan lines G₁ to Gₙ. Each interleaved data line and scan line define a display unit. For example, the data line D₁ and scan line G₁ define the display unit 100. As shown in FIG. 1, the equivalent circuit of the display unit 100 (also the same as other display unit) comprises the transistor TFT, capacitor Cs and the liquid crystal capacitor Clc.

During operation of the liquid crystal display, the data lines may be broken. Please refer to FIG. 2. FIG. 2 is a schematic of a data line repair mechanism in the conventional liquid crystal display. The liquid crystal display comprises a plurality of rescue lines to repair the defective data line. Take the rescue lines R₁ and R₂ for example, when the data line D₂ is broken at node B, the display units after node C cannot be driven by the conventional driving mechanism. The conventional repair mechanism selects a rescue line, rescue line R₁, to electrically connect the rescue line R₁ and both ends of the data line D₂ at the connection nodes C₁ and C₂. The display data originally transmitted to the data line D₂ is therefore transmitted to the rescue line R₁. Thus, the display units between the node B and the connection C₂ can be normally driven due to the rescue line R₁ and the display error is limited to node B. However, as shown in FIG. 2, two connection nodes are required when the data line fails, and this increases the repair time and potential for liquid crystal display damage.

### BRIEF SUMMARY OF THE INVENTION

An embodiment of data line repair mechanism for a display is disclosed. The display comprises a data driver, a plurality of data lines, at least one rescue line, wherein each of the data lines comprises a second end and a first end coupled to the data driver, the rescue line is coupled to the data driver, and when a first data line of the data lines fails, the rescue line is coupled to the second end of the first data line via a single one weld point. The mechanism comprises an address storage unit and a data processor. The address storage unit stores the addresses of the first data line and the rescue line. The data processor receives an input data to output an output data to the data driver, wherein the input data comprises a plurality of display data corresponding to the data lines, a first display data corresponds to the first data line, and the data processor transmits the first display data to the rescue line based on the addresses of the first data line and the rescue line.

An embodiment of a data line repair method for a display is disclosed. The method comprises: storing an address of a defective data line, wherein the defective data line comprises a second end and a first end coupled to a data driver; providing/or selecting a rescue line based on the polarity of the first data line, wherein the rescue line is coupled to a spare data driver and comprises an extension part near to the second end of the defective data line; electrically connecting the extension part with the second end of the defective data line by a single one weld point; and correcting an output data based on the addresses of the defective data line and the rescue line and transmitting the corrected output data to the data driver and the spare data driver, the step of which may be transmitting a corrected output data for an output data based on the addresses of the defective data line and the rescue line to the data driver and the spare data driver.

An embodiment of a display with a data line repair mechanism is disclosed. The display comprises a data driver, a plurality of data lines, a gate driver, a plurality of gate lines, a defective data line, a rescue line and a single one weld point. The data driver comprises a plurality of driving units and at least one spare data driver, wherein the spare data driver is located at the end of the data driver. Each data line comprises a second end and a first end coupled to one of the driving units. The gate lines are coupled to the gate driver to form a matrix structure with the data lines. The defective data line comprises a second end and a first end coupled to another of the driving units. The rescue line is coupled to the spare driving unit and comprises an extension part. The weld point is electrically connected to the extension part and the second end of the defective data line.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic diagram of a conventional liquid crystal display.

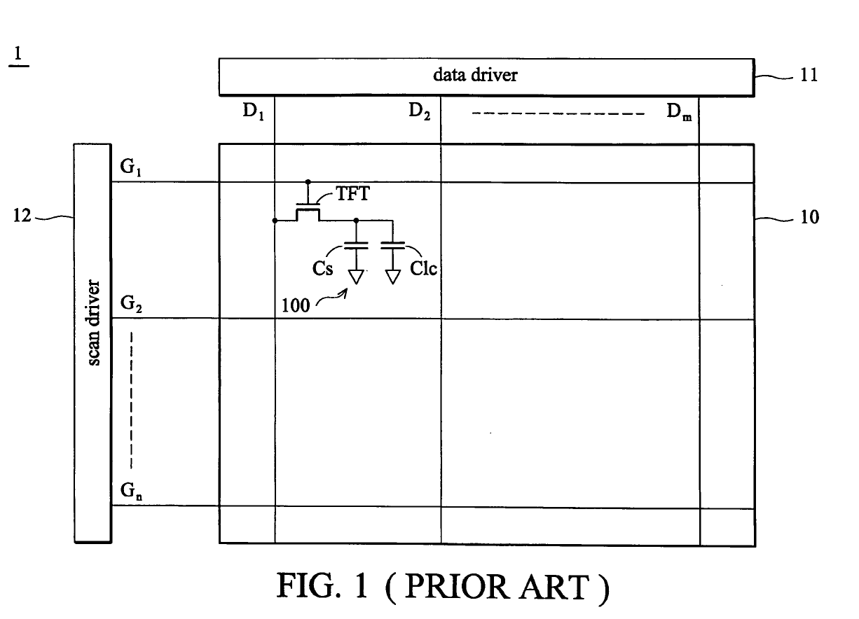

FIG. 2 is a schematic diagram of a data line repair mechanism in conventional liquid crystal displays.

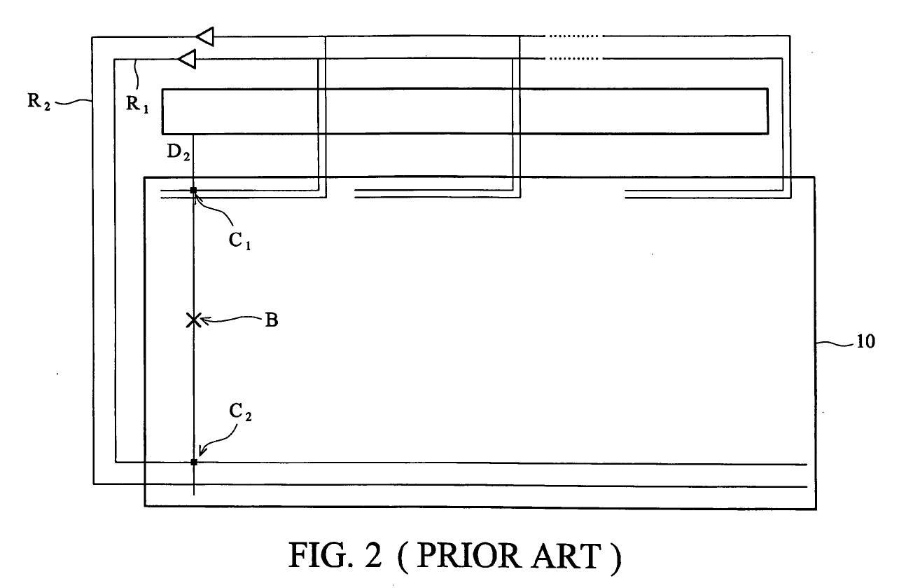

FIG. 3 is a schematic diagram of a liquid crystal display with a data line repair mechanism according to an embodiment of the invention.

FIG. 4 is a schematic diagram of a data line repair mechanism according to an embodiment of the invention.

FIG. 5 is a schematic diagram of an output data after the data line repair of the liquid crystal display in FIG. 4.

FIG. 6 is a schematic diagram of a data line repair mechanism according to another embodiment of the invention.

FIG. 7 is a schematic diagram of the output data after the data line repair of the liquid crystal display in FIG. 6.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

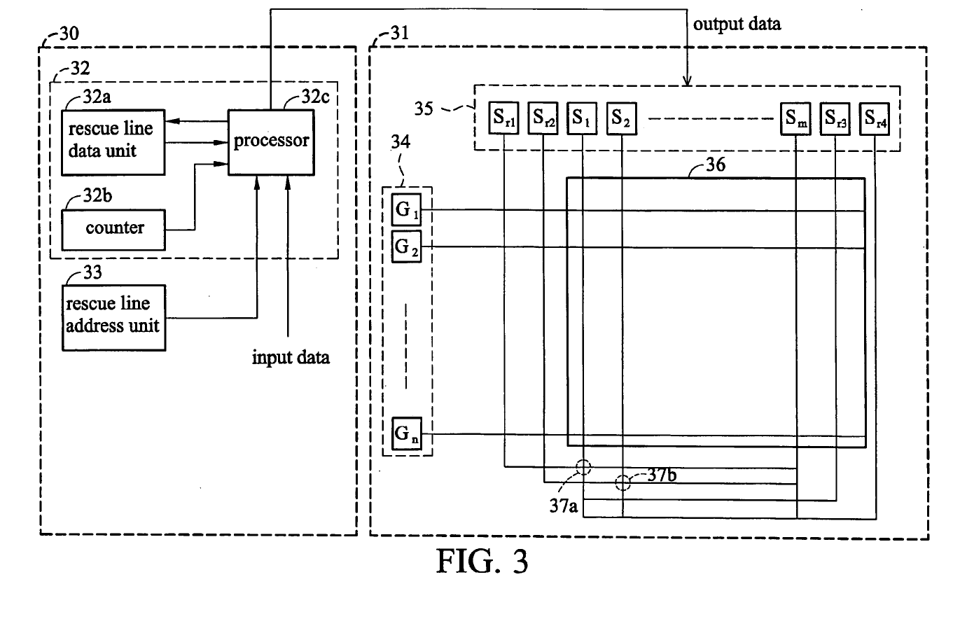

FIG. 3 is a schematic diagram of a liquid crystal display with a data line repair mechanism according to an embodiment of the invention. The data line repair mechanism 30 comprises timing controller 32 and rescue line address unit 33. The timing controller 32 further comprises rescue line data unit 32a, counter 32b and a processor 32c. The counter 32b counts the gate lines. When the counter 32b counts the location of the gate line corresponding to the defective point, the input data is converted to a data compatible to the data line repair situation and is transmitted to corresponding data line. The liquid crystal display 31 comprises a gate driver 34 and a source driver (or so-called data driver) 35. The gate driver 34 comprises a plurality of gate driving units, such as G₁, G₂ and Gₙ, for driving the corresponding gate lines in the pixel array 36. The source driver 35 comprises a plurality of source driving units, such as S₁, S₂ and Sₘ, for driving corresponding data lines (or so-called source lines). Typically, due to the limitation of the display area, spare data lines and spare source driving units, such as Sᵣ₁, Sᵣ₂, Sᵣ₃ and Sᵣ₄, are provided. For example, if the resolution of the pixel array 36 is 1024×768, this indicates that the pixel array 36 comprises (1024+R_{S}) data lines and (768+R_{G}) gate lines, wherein R_{S} represents the number of the spare data lines (or so-called rescue data lines or rescue lines), and R_{G} represents the number of the spare gate lines. The spare data lines and spare gate lines are mainly for the repair of the defective data lines and gate lines. Thus, the number of the corresponding source driving units is more than 1024. In this embodiment, the data line repair mechanism is implemented by the spare data lines and spare data driving units. Typically, the spare data lines and spare gate lines are located at one side or both sides of the pixel array 36. In this embodiment, the spare data lines and spare data driving units located at both sides of the pixel array 36 are taken as an example. When the data lines driven by the source driving units S₁ and S₂ fail, the spare data line driven by the spare source driving unit Sᵣ₁ is used to repair the defective data line via the weld points 37a or 37b. Furthermore, the driving ability of the source driving unit decreases due to the increase of the length of the data line, in other words, the driving current or driving voltage decreases due to the increase of the length of the data line. In another embodiment, the selection of the spare data line is based on the location of the defective data line. For example, if the data line driven by the source driving unit Sₘ fails, the data lines driven by the spare driving unit Sᵣ₃ and Sᵣ₄ are preferred for the data line repair.

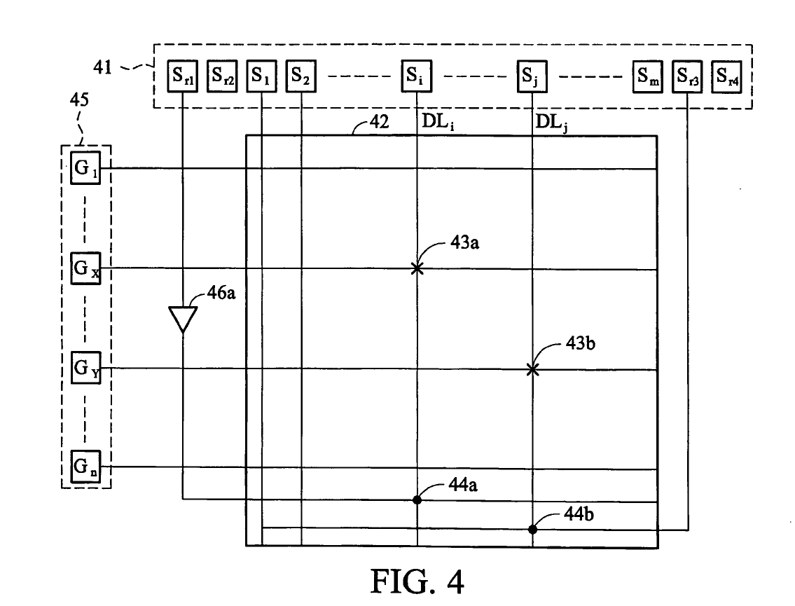

FIG. 4 is a schematic diagram of a data line repair mechanism according to an embodiment of the present invention. The gate driver 45 comprises a plurality of gate driving units, such as G₁, G₂ and Gₙ, for driving the corresponding gate lines in the pixel array 42. The source driver 41 comprises a plurality of source driving units, such as S₁, S₂ and Sₘ, for driving corresponding data lines (or so-called source lines). In this embodiment, the source driver 41 further comprises spare source driving units, such as Sᵣ₁, Sᵣ₂, Sᵣ₃ and Sᵣ₄, to drive the corresponding data line. As shown in FIG. 4, the spare source driving units Sᵣ₁ and Sᵣ₂ are located at the left side of the source driver 41, and the spare source driving units Sᵣ₃ and Sᵣ₄ are located at the right side of the source driver 41. But the spare source driving units Sᵣ₁, Sᵣ₂, Sᵣ₃ and Sᵣ₄ may be arranged at other locations of the source driver 41 according to any design rule for application. In this embodiment, the data lines DLᵢ and DLⱼ, respectively driven by the source driving unit Sᵢ and Sⱼ are broken, respectively at the nodes 43a and 43b. In this embodiment, the data line DLᵢ driven by the source driving unit Sᵢ is repaired by the spare data line driven by the spare source driving units Sᵣ₁. The repair mechanism uses laser to form a weld point 44a at the connection of the data line DLᵢ and spare data line driven by the spare source driving units Sᵣ₁. In another embodiment, the data line driven by the spare source driving units Sᵣ₁ and the data line DLᵢ are at different layers and the repair mechanism drills a via at the connection of the data line DLᵢ and spare data line driven by the spare source driving units Sᵣ₁ first, and then injects the conductive material to the via to allow an electrical connection between the data line driven by the spare source driving units Sᵣ₁ and the data line DLᵢ. In this embodiment, the data line DLⱼ driven by the source driving unit Sⱼ is repaired by the spare data line driven by the spare source driving units Sᵣ₃. The repair mechanism uses laser to form a weld point 44a at the connection of the data line DLⱼ and spare data line driven by the spare source driving units Sᵣ₃. In another embodiment, the data line driven by the spare source driving units Sᵣ₃ and the data line DLⱼ are at different layers and the repair mechanism drills a via at the connection of the data line DLⱼ and spare data line driven by the spare source driving units Sᵣ₃ first, and then injects the conductive material to the via to allow an electrical connection between the data line driven by the spare source driving units Sᵣ₃ and the data line DLⱼ. The repair mechanisms for the data lines DLᵢ and DLⱼ are substantially the same, and the only difference is that an enhenser, for example a uni-gain buffer, is applied in the repair mechanism of the data line DLᵢ to increase the driving ability of the source driving unit Sᵢ. In another embodiment, the uni-gain buffer can be replaced by an amplifier to increase the driving ability of the source driving unit Sᵢ.

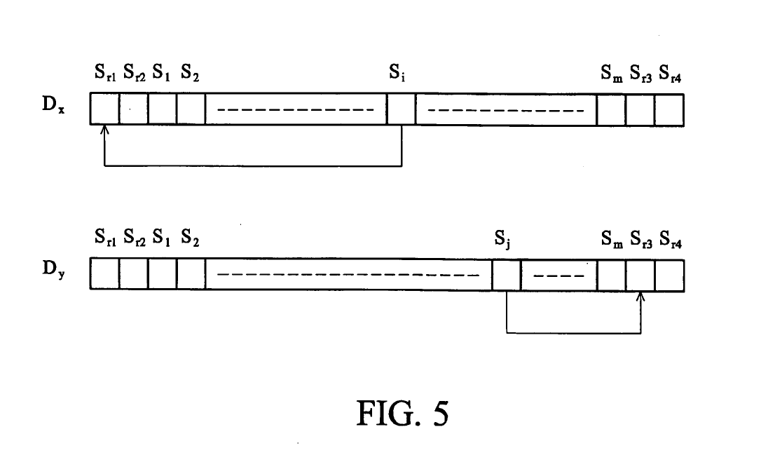

After the repair of the defective data line in a liquid crystal display, the data input to the liquid crystal display has to be adjusted to assure that the corresponding image can be normally displayed in the liquid crystal display. FIG. 5 is a schematic diagram of an output data after the data line repair of the liquid crystal display in FIG. 4. In FIG. 5, Dₓ represents the output data of the whole source driving units of the source driver 41 when the gate driving unit Gₓ is turned on. When the driving unit Gₓ is turned on, the data line DLᵢ is broken and the data cannot be normally transmitted via the data line DLᵢ, thus, the data is transmitted via the data line driven by the spare source driving units Sᵣ₁ after the data line is repaired. Furthermore, when the driving units between the gate driving unit Gₓ and the gate driving unit Gₙ are tuned on, the data originally transmitted by the source driving unit Sᵢ will be copied and transmitted by both of the source driving units Sᵢ and Sᵣ₁. In another embodiment, the data originally transmitted by the source driving unit Sᵢ is copied and transmitted by the spare source driving unit Sᵣ₁ without regard to the position of the gate driving unit Gₓ corresponding to the broken node 43a. For further illustration, please refer to FIG. 3. The rescue line address unit 33 stores and transmits the addresses of the data line DLᵢ and the spare data line driven by the source driving unit Sᵣ₁ to the processor 32c. When the counter 32b counts to the x^{th} gate line (the gate line corresponding to the broken node 43a), the processor 32c transmits the input data to the rescue line data unit 32a based on the addresses of the data line DLᵢ and the spare data line driven by the spare source driving unit Sᵣ₁. The arrangement of the input data will be adjusted and the data originally transmitted by the source driving unit Si is copied and transmitted by the spare source driving unit Sᵣ₁. Similarly, the repair mechanism of the data line DLⱼ is substantially similar to the repair mechanism of the data line DLᵢ, and therefore, further description is omitted for briefly.

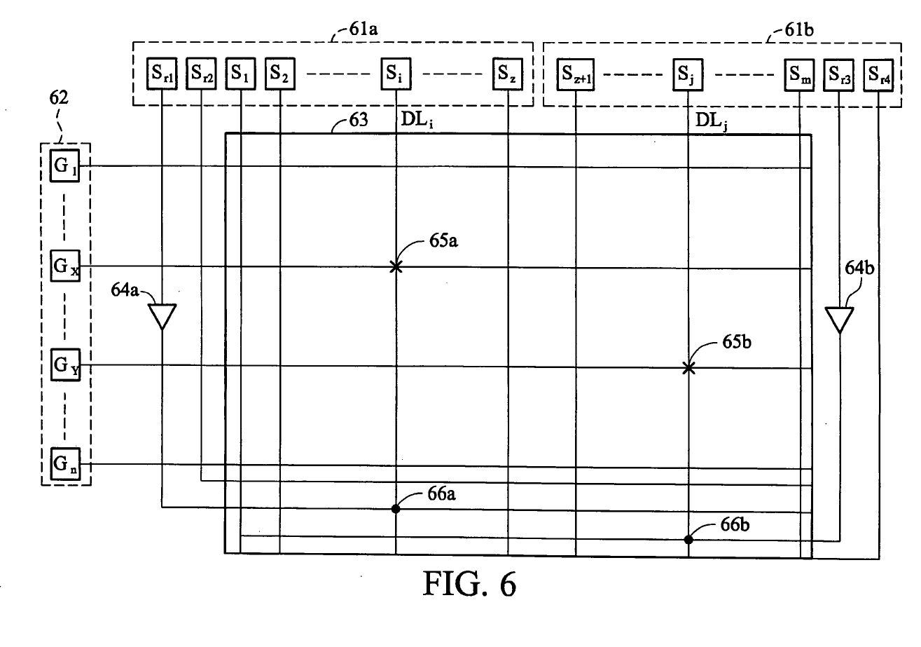

FIG. 6 is a schematic diagram of a data line repair mechanism according to another embodiment of the present invention. The gate driver 62 comprises a plurality of gate driving units, such as G₁, G₂ and Gₙ, for driving the corresponding gate lines in the pixel array 63. The first source driver 61a comprises a plurality of source driving units, such as S₁, S₂ and S_{z}, for driving corresponding data lines (or so-called source lines). The second source driver 61b comprises a plurality of source driving units, such as S_{z+1}, Sⱼ and Sₘ, for driving corresponding data lines (or so-called source lines). In this embodiment, when the data line driven by the first data driver 61a fails, the rescue lines driven by the spare data driving unit, such as the spare driving units Sᵣ₁ and Sᵣ₂, are used to repair the defective data line. When the data line driven by the first data driver 61b fails, the rescue lines driven by the spare data driving unit, such as the spare source driving units Sᵣ₃ and Sᵣ₄, are used to repair the defective data line. In FIG. 6, the data line DLᵢ and DLⱼ driven by the driving units Sᵢ and Sⱼ are broken, respectively at the broken nodes 65a and 65b. In this embodiment, the data line DLᵢ driven by the source driving unit Sᵢ is repaired by the rescue line driven by the spare driving units Sᵣ₁. The repair mechanism uses a laser to form a weld point 66a at the connection of the data line DLᵢ and rescue line driven by the spare source driving units Sᵣ₁ to allow an electrical connection of the data line DLᵢ and rescue line driven by the spare source driving units Sᵣ₁. The data line DLⱼ driven by the source driving unit Sⱼ is repaired by the rescue line driven by the spare driving units Sᵣ₃. The repair mechanism uses a laser to form a weld point 66b at the connection of the data line DLⱼ and rescue line driven by the spare source driving units Sᵣ₃ to allow an electrical connection of the data line DLⱼ and rescue line driven by the spare source driving units Sᵣ₃. Furthermore, to avoid decreasing driving ability of the spare source driving units Sᵣ₁ and Sᵣ₃, the uni-gain buffer 64a and 64b are applied to increase the driving ability of the spare source driving units Sᵣ₁ and Sᵣ₃. In another embodiment, the uni-gain buffer can be replaced by an amplifier to increase the driving ability of the spare source driving units Sᵣ₁ and Sᵣ₃.

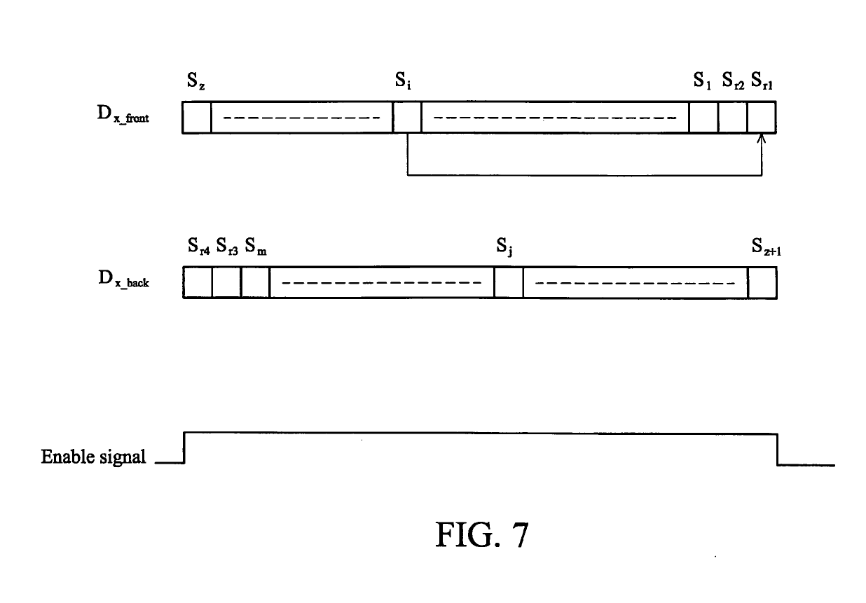

FIG. 7 is a schematic diagram of the output data after the data line repair of the liquid crystal display in FIG. 6. The first source driver 61a and the second source driver 61b output data in a cycle when the enable signal is at a logic high level. Dₓ_{_{—}}_{front} represents the data output by the whole driving units of the first source driver 61a. Dₓ_{_{—}}_{back} represents the data output by the whole driving units of the second source driver 61b. When the gate driving unit Gₓ is turned on, the data cannot be normally transmitted by the source driving unit Sᵢ due to the defective of data line DLᵢ. In this embodiment, the data output by the second source driver 61b does not change because the data lines driven by the second source driver 61b is not defective. The pixels after the broken node 43a cannot be normally driven, thus, the data originally transmitted by the source driving unit Sᵢ will be copied and transmitted both by the spare source driving units Sᵣ₁. Furthermore, when the driving units between the gate driving unit Gₓ and the gate driving unit Gₙ are turned on, the data originally transmitted by the source driving unit Sᵢ will be copied and transmitted both by the spare source driving unit Sᵣ₁. For further illustration, please refer to FIG. 3. The rescue line address unit 33 stores and transmits the addresses of the data line DLᵢ and the spare data line driven by the source driving unit Sᵣ₁ to the processor 32c. When the counter 32b counts to the x^{th} gate line (the gate line corresponding to the broken node 66a), the processor 32c transmits the input data to the rescue line data unit 32a based on the addresses of the data line DLᵢ and the spare data line driven by the spare source driving unit Sᵣ₁. The arrangement of the input data will be adjusted and the data originally transmitted by the source driving unit Si is copied and transmitted by the spare source driving unit Sᵣ₁. Similarly, the data rearrangement of the data of the pixels after the broken node 65b is substantially the same as described, and therefore, further description is omitted for briefly. In the described embodiment, selection of the spare data line is based on the polarity of the defective data line. In other words, the polarity of signal transmitted via the rescue line is the same as the signal transmitted via the polarity of the first data line.

From above, the embodiments of the present invention provide a data line repair method for a display, comprising: storing an address of a defective data line DLᵢ, wherein the defective data line DLᵢ comprises a second end and a first end coupled to a data driver Sᵢ; providing a rescue line based on the polarity of the first data line DL₁, wherein the rescue line is coupled to a spare data driver Sᵣ₁ (for example) and comprises an extension part near to the second end of the defective data line DLᵢ; electrically connecting the extension part with the second end of the defective data line DLᵢ by a single one weld point 44a; and transmitting a corrected output data for an output data based on the addresses of the defective data line DLᵢ and the rescue line to the data driver Sᵢ and the spare data driver Sᵣ₁. The output data comprises a plurality of display data and, wherein the rescue line outputs a first display data of the plurality of display data corresponding to the defective data line DLᵢ. The corrected output data is allocated before or after the output data based on the address of the rescue line. The extension part and the defective data line are substantially perpendicular to each other. The method further comprising counting the output data by a counter 32b, wherein when the counting result of the counter 32b and the address of the defective data line DLᵢ are matched, the first display data is transmitted and temporally stored in a data storage unit.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A data line repair mechanism for a display comprising a data driver, a plurality of data lines, at least one rescue line, wherein each of the data lines comprises a second end and a first end coupled to the data driver, the rescue line is coupled to the data driver, and when a first data line of the data lines fails, the rescue line is coupled to the second end of the first data line via a single one weld point, wherein the data line repair mechanism comprises:
an address storage unit configured to store the addresses of the first data line and the rescue line; and
a data processor configured to output an output data to the data driver in response to an input data comprising a plurality of display data corresponding to the data lines, wherein the data processor transmits a first display data corresponding to the first data line to the rescue line based on the addresses of the first data line and the rescue line.

2. The mechanism as claimed in claim 1, further comprising a counter configured to count the display data.

3. The mechanism as claimed in claim 2, further comprising a data storage unit, wherein when the counting result of the counter and the address of the first data line are matched, the data processor transmits and temporally stores the first display data in the data storage unit.

4. The mechanism as claimed in claim 1, wherein the polarity of the rescue line is the same as that of the first data line.

5. The mechanism as claimed in claim 1, further comprising an enhenser coupled to the rescue line to increase the driving ability of the data driver.

6. The mechanism as claimed in claim 5, wherein the enhenser is a uni-gain buffer or an amplifier.

7. The mechanism as claimed in claim 1, wherein the rescue line comprises an extension part and, the extension part and the first data line are substantially perpendicular to each other.

8. A data line repair method for a display, comprising:
storing an address of a defective data line, wherein the defective data line comprises a second end and a first end coupled to a data driver;
providing a rescue line based on the polarity of the first data line, wherein the rescue line is coupled to a spare data driver and comprises an extension part near to the second end of the defective data line;
electrically connecting the extension part with the second end of the defective data line by a single one weld point; and
transmitting a corrected output data for an output data based on the addresses of the defective data line and the rescue line to the data driver and the spare data driver.

9. The method as claimed in claim 8, wherein the output data comprises a plurality of display data and, wherein the rescue line outputs a first display data of the plurality of display data corresponding to the defective data line.

10. The method as claimed in claim 9, wherein the corrected output data is allocated before or after the output data based on the address of the rescue line.

11. The method as claimed in claim 8, wherein the extension part and the defective data line are substantially perpendicular to each other.

12. The method as claimed in claim 8, further comprising counting the output data by a counter, wherein when the counting result of the counter and the address of the defective data line are matched, the first display data is transmitted and temporally stored in a data storage unit.

13. A display, comprising:
a data driver comprising a plurality of driving units and at least one spare data driver, wherein the spare data driver is located at the end of the data driver;
a plurality of data lines, wherein each data line comprises a second end and a first end coupled to one of the driving units;
a gate driver;
a plurality of gate lines coupled to the gate driver, to form a matrix structure with the data lines;
a defective data line comprising a second end and a first end coupled to another of the driving units;
a rescue line coupled to the spare driving unit and comprising an extension part; and
a single one weld point electrically connected to the extension part and the second end of the defective data line.

14. The display as claimed in claim 13, further comprising an enhenser coupled to the rescue line to increase the driving ability of the data driver.

15. The display as claimed in claim 14, wherein the enhenser is a uni-gain buffer or an amplifier.

16. The display as claimed in claim 13, further comprising an address storage unit configured to store the addresses of the defective data line and the rescue line

17. The display as claimed in claim 13, further comprising a data processor configured to output an output data to the data driver in response to an input data comprising a plurality of display data corresponding to the data lines, wherein the data processor transmits a first display data corresponding to a first data line to the rescue line based on the addresses of the first data line and the rescue line.

18. The display as claimed in claim 17, further comprising a counter configured to count the display data.

19. The display as claimed in claim 18, further comprising a data storage unit, wherein when the counting result of the counter and the address of the first data line are matched, the data processor transmits and temporally stores the first display data in the data storage unit.
